(19) United States
(12) Patent Application Publication
(10) Pub. No.: US 2010/0068473 A1
(43) Pub. Date: Mar. 18, 2010

(54) Decorative article for wall corner

(76) Inventor: Zandra de la Rosa, Gardena, CA (US)

Correspondence Address: DAVID AND RAYMOND PATENT FIRM, 108 N. YNEZ AVE., SUITE 128, MONTEREY PARK, CA, 91754, US

(21) Appl. No.: 12/284,120

(22) Filed: Sep. 17, 2008

(51) Int. Cl. B32B 3/10

(52) U.S. Cl. 428/195.1

(57) ABSTRACT

A decorative article for mounting on a wall corner formed by a first wall surface and a second wall surface integrally extended from the first wall surface to form a predetermined angle of inclination with the first wall surface, wherein the angle of inclination is less than one hundred and eighty degrees. The decorative article includes a first decorative sheet and a second decorative sheet. The first decorative sheet is detachably attached onto the first wall surface and has a predetermined first poster pattern formed thereon. The second decorative sheet is also detachably attached onto the second wall surface in an edge-to-edge manner with the first decorative sheet, and has a predetermined second poster pattern formed thereon, in such a manner that the first and the second poster patterns are optimally harmonized to create a three dimensional decorative effect for the wall corner.

### BACKGROUND OF THE PRESENT INVENTION

1. Field of Invention

The present invention relates to a decorative article, and more particularly to a decorative article for wall corner, which fully utilities the corner area of the wall to create a specifically designed three dimensional decorative effect to the wall corner.

2. Description of Related Arts

A conventional decorative article, such as a poster, usually comprises a single poster sheet attached on a flat surface, such as a wall surface for providing decoration to the relevant space. The poster sheet is printed with a predetermined colors or aesthetic pattern to provide the most desirable decoration for that space. For example, a poster sheet may be printed a large figurine of the Spiderman or Superman so that fans of Spiderman or Superman are able to illustrate their devotion or particular favor towards the relevant character.

Since a conventional poster may be very cheap in price, and is widely available from many poster stores, it is widely utilized by many people throughout the country. Yet there exists a number of disadvantages regarding this kind of conventional poster. First, the decorative effect of conventional poster is plain in style and inflexible in aesthetic appearance. Very often, a user of the conventional poster would feel very bored soon after he or she has attached the poster onto a wall. Second, a conventional poster is only capable of illustrating a two-dimensional aesthetic effect of a particular aesthetic pattern, because a conventional poster (i.e. the poster sheet) is inherently two-dimensional in physical structure. Although a decorative pattern can be drawn to imitate a three-dimensional effect, imitating a three-dimensional decorative pattern on a two-dimensional poster sheet would never achieve a truly three-dimensional visual effect.

As a matter of fact, instead of using poster, one may actually attach a physical object, such as a mini-accessory, onto a wall to decorate a particular location. Unfortunately, this does not resolve the problem of traditional poster as mentioned above. The use of a real three dimensional object reflects the user's recognition of the difference between a truly three-dimensional decorative effect and a seemingly three dimensional decorative effect imitated by a two dimensional decorative pattern. Moreover, a three-dimensional object is more difficult to be attached onto a flat surface. Very often, intrusive or destructive mounting means must be utilized in order to securely mount a three-dimensional object onto a flat surface.

### SUMMARY OF THE PRESENT INVENTION

A main object of the present invention is to provide a decorative article which is capable of creating a specifically designed three dimensional decorative effect to a wall corner.

Another object of the present invention is to provide a decorative article comprising a first and a second decorative sheet adapted for detachably attaching onto two flat surfaces in a side-by-side manner so as to create a truly three dimensional decorative effect in a predetermined location.

Another object of the present invention is to provide a decorative article comprising a first decorative sheet, a second decorative sheet, and a decorative accessory kit arranged to be attached to at least one of the first and the second decorative sheet so as to further enhance the three-dimensional decorative effect of the present invention.

Another object of the present invention is to provide a decorative article, wherein the decorative accessory kit comprises a wide variety of kit members for providing extensive three-dimensional decorative effect to a wall corner.

Accordingly, in order to accomplish the above objects, the present invention provides a decorative article for mounting on a wall corner having a first wall surface and a second wall surface adjacently extending therefrom along a common edge with an angle between the first and second wall surfaces being less than 180°, wherein the decorative article comprises:

a first decorative sheet having a first attaching side adapted for detachably attaching on the first wall surface, and a first decorative side containing a first decorative pattern thereon; and

a second decorative sheet having a second attaching side adapted for detachably attaching on the second wall surface, and a second decorative side containing a second decorative pattern thereon, wherein the first and second decorative sheets are aligned with the common edge of the wall corner that the first and second decorative patterns are harmonized to create a three dimensional decorative effect for the wall corner.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of the decorative article according to a preferred embodiment of the present invention.

FIG. 2 is a perspective view of the decorative article according to the above preferred embodiment of the present invention.

FIG. 3 is another schematic diagram of the decorative article according to the above preferred embodiment of the present invention.

### DETAILED DESCRIPTION OF THE PREFERRED EMBODIMENT

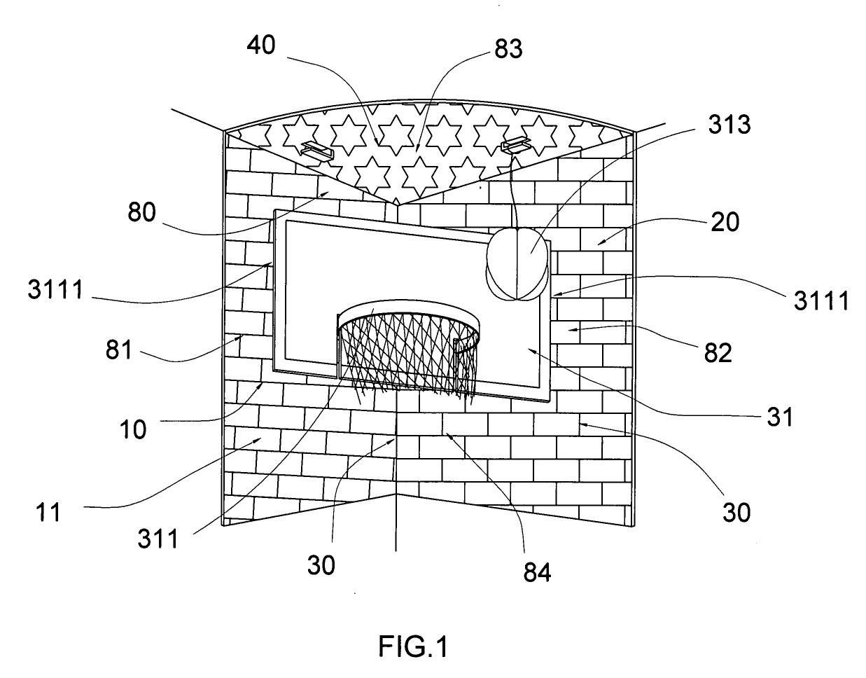

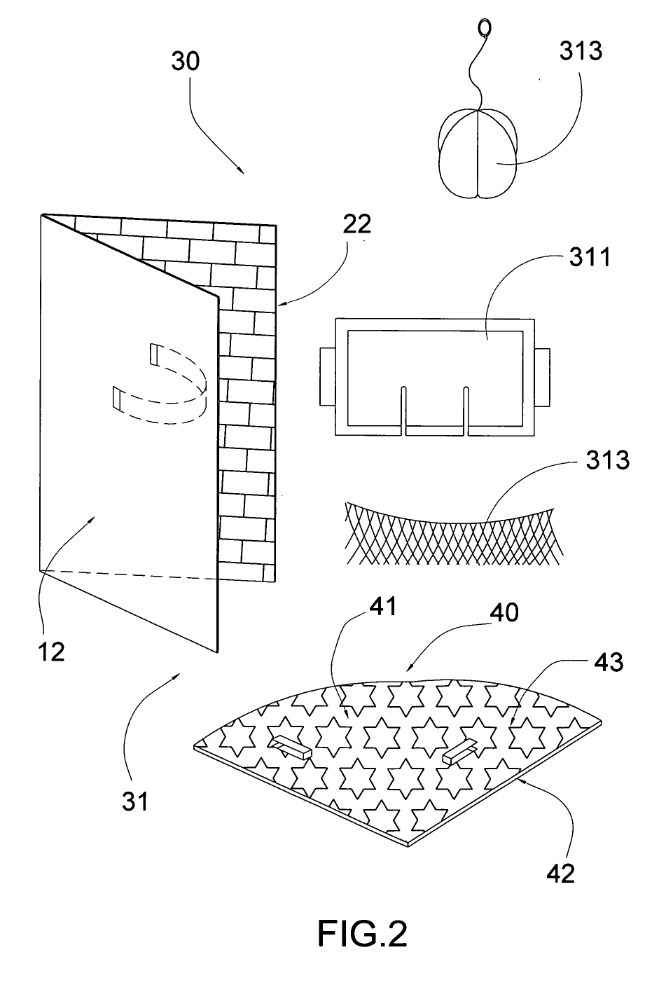

Referring to FIG. 1 to FIG. 2 of the drawings, a decorative article for a wall corner 80 according to a preferred embodiment of the present invention is illustrated, in which the three dimensional poster comprises a first decorative sheet 10 and the second decorative sheet 20. The wall corner 80 is formed by a first wall surface 81 and a second wall surface 82 integrally extended from the first wall surface 81 to form a predetermined angle of inclination (preferably less than 180°) with the first wall surface 81, wherein the angle of inclination is less than one hundred and eighty degrees so that the first decorative sheet 10 and the second decorative sheet 20 are capable of forming a truly three-dimensional decorative effect. The wall corner 80 can further comprise a ceiling wall surface 83 integrally extended on top of the first and the second wall surfaces 81, 82, and may further comprise a floor wall surface 85 integrally extended on a bottom edge of the first and the second wall surfaces 81, 82. In other words, the wall corner 80 further has a decoration cavity 84 formed within the first wall surface 81, the second wall surface 82, and the ceiling wall surface 83.

The first decorative sheet 10 has a first attaching side 12 is detachably attached onto the first wall surface 81, wherein the first decorative sheet 10 also has a first decorative side 13 forming a predetermined first poster pattern 11 thereon.

The second decorative sheet 20 has a second attaching side 22 detachably attached onto the second wall surface 82 in an edge-to-edge manner with the first decorative sheet 10, wherein the second decorative sheet 20 also has second decorative side 23 forming a predetermined second poster pattern 21 thereon, in such a manner that the first and the second poster patterns 11, 21 are optimally harmonized to create a three dimensional decorative effect for the wall corner 80.

According to the preferred embodiment of the present invention, the first decorative sheet 10 is made of light and flexible materials, such as very thin plastic or paper material, so as to allow convenient attachment on and detachment from the first wall surface 81 of the wall corner 80. Similarly, the second decorative sheet 20 is also made of light and flexible materials, such as very thin plastic or paper material, so as to allow convenient attachment on and detachment from the second wall surface 82 of the wall corner 80. It is worth mentioning that the first and the second poster patterns 11, 21 are specifically designed and harmonized to create a predetermined decorative theme of the wall corner 80. For example, as shown in FIG. 1 and FIG. 2 of the drawings, the first and the second poster patterns 11, 21 can be specifically designed to imitate a basketball playing theme, such as the environment surrounding the basketball rim.

The first and second decorative sheets 10, 20 are integrally extended along a folding line 30 such that the first and second decorative sheets 10, 20 are folded in an overlapped manner at the folding line and are unfolded for attaching to the first and second wall surfaces 81, 82 respectively to align the folding line 30 with the common edge.

The decorative article further comprises a third decorative sheet 40 having a third attaching side 42 adapted for detachably attaching on a third wall surface 83 that one of the first, second, and third wall surfaces 81, 82, 83 is a ceiling wall surface, and a third decorative side 43 containing a third decorative pattern 41 thereon to harmonize with the first and second decorative patterns 11, 21 so as to create a three dimensional decorative effect for the wall corner 80.

In order to further enhance the three dimensional decorative effect of the present invention, the decorative article further comprises a decorative accessory kit 30 adapted for providing a plurality of accessory elements 31 attached to a specific location on the wall corner 80 so as to enhance the three dimensional decorative effect of the decorative article. Each of the accessory elements 31 may be embodied as different decorative instrumentalities or devices which are fit for particular decorative themes. In other words, the decorative accessory kit 30 is provided at the first and second decorative sheets 10, 20 for outwardly protruding from the first and second wall surfaces 81, 82 to enhance the three dimensional decorative effect at the wall corner 80.

The first through third attaching sides 12, 22, 42 are three laminating sides adapted for reusably attaching to the first through third wall surfaces 81, 82, 83 respectively and for being removably peeled off from the first through third wall surfaces 81, 82, 83 respectively.

Thus, at least one of the accessory elements 31 is embodied as a pop-up ornamental element 311 extended from at least one of the first and the second decorative sheets 10, 20 into the decoration cavity 84 of the wall corner 80. As shown in FIG. 1 of the drawings, the pop-up ornamental element 311 is preferably embodied as a basketball backboard popped out from the first and the second decorative sheets 10, 20 for imitating a real basketball backboard. Thus, the pop-up ornamental element 311 provides a unique basketball environment as the three-dimensional decorative effect of the present invention. In addition, the pop-up ornamental element 311 may contain a logo or slogan (such as NBA) for suiting a particular three dimensional decorative theme.

It is worth mentioning that the ornamental element 311 has two peripheral sides 3111 integrally extended from the first and second decorative sheets 10, 20 respectively, such that when the first and second decorative sheets 10, 20 are unfolded for attaching on the first and second wall surfaces 81, 82 respectively, the ornamental element 311 is outwardly popped between the first and second decorative sheets 10, 20.

Moreover, at lease one of the accessory elements 31 is embodied as an attachment fixture 312 mounted in the decoration cavity 84 for providing truly three dimensional articles or an attachment as the three dimensional decorative effect of the decorative article. In this preferred embodiment of the present invention as shown in FIG. 1 of the drawings, the attachment fixtures 312 is embodied as a basketball hoop and a basket ball net mounted on the pop-up ornamental element 311 for accurately imitating a true basketball environment within the decorative cavity 84. When the attachment fixtures 312 is attached in the decorative cavity 84, the decorative article is unique in providing a truly three dimensional fixture for creating a genuine three dimensional decorative effect from three dimensional objects (i.e. the accessory elements 31) without requiring to convert a three dimensional image into a two dimensional poster as in the case of conventional posters. Moreover, the attachment fixture 312 is mounted on said pop-up ornamental element 311 for optimally blending different ornamental effect of the attachment fixture 312 and the ornamental element 311 to optimally create the three dimensional decorative effect.

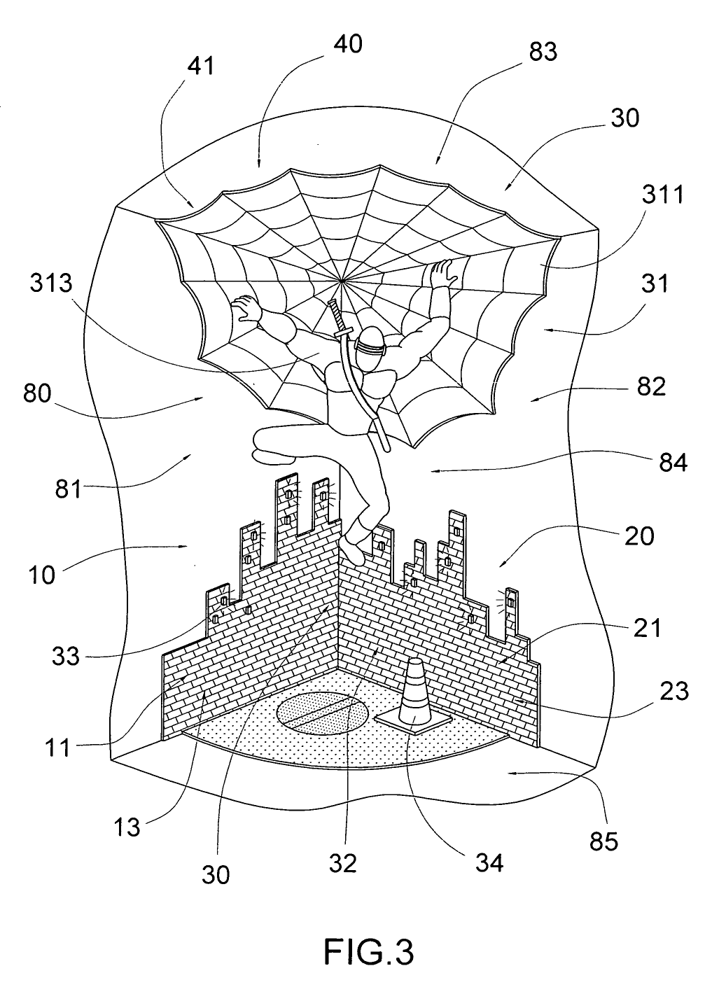

In other to further enhance the three dimensional decorative effect of the present invention, at least one of the accessory elements 31 is embodied as a hanging element 313 suspendedly mounted from the ceiling wall surface 83 (i.e. the third decorative sheet 40) or the first or the second decorative sheet 10, 20 for further enhancing an aesthetic and decorative configuration of the decorative article. As shown in FIG. 1 and FIG. 3 of the drawings, the hanging element 313 are embodied as a basketball-related ornaments or a character figurine element suspendedly hanging from the ceiling wall surface 83 or the first and the second decorative sheet 10 (20) for further enhancing the three dimensional decorative effect of the decorative article of the present invention.

The decorative accessory kit 30 further comprises a texture element 32 selectively attached to at least one of the first and second decorative sheets 10, 20 at the first and second decorative sides 13, 23 thereof to create a three dimensional decorative effect with real texture enhancement.

Moreover, the decorative accessory kit 30 further comprises an illumination element 33 selectively attached to at least one of the first and second decorative sheets 10, 20 at the first and second decorative sides 13, 23 thereof to create a three dimensional decorative effect with light enhancement.

The decorative accessory kit 30 further comprises at least one decorative unit 34 disposed in the wall corner 84 on the ground or the floor wall surface 85 for further enhancing three-dimensional effect of the decorative article. The decorative unit 34 can be selected from a wide variety of objects consistent with the theme or environment of the other decorative patterns (11), (21), (41).

Referring to FIG. 3 of the drawings, the three dimensional decorative effect of the decorative article can be designed to imitate a specific environment associated with a specific character. For example, the three dimensional decorative effect can be designed to impart a SPIDERMAN character figurine environment for the wall corner 80. Thus, the pop-up ornamental element 311 is embodied as a spider net popped out from the first and the second decorative sheets 10, 20.

In addition, the attachment fixture 312 is embodied as a background pattern for the SPIDERMAN and is attached onto the pop-up ornamental element 311 (the spider net in this case) so that the three dimensional decorative effect possess a unique SPIDERMAN-related environment for SPIDERMAN fans.

Furthermore, each of the hanging units 313 may be embodied as mini spiders and SPIDERMAN model or other decorative ornamentals suspendedly hanging from the ceiling wall surface 83 or from the first or the second wall posters 10, 20. It is worth mentioning that each of the hanging units 313 may be embodied as having different ornamental effects so that when all of the hanging units 313 are attached in the decorative cavity 84, the pop-up ornament elements 311, the attachment fixture 312, and then hanging units 313 combine to create a unique and optimal three dimensional decorative effect.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A decorative article for mounting on a wall corner having a first wall surface and a second wall surface adjacently extending therefrom along a common edge with an angle between said first and second wall surfaces being less than 180°, wherein said decorative article comprises:
a first decorative sheet having a first attaching side adapted for detachably attaching on said first wall surface, and a first decorative side containing a first decorative pattern thereon; and
a second decorative sheet having a second attaching side adapted for detachably attaching on said second wall surface, and a second decorative side containing a second decorative pattern thereon, wherein said first and second decorative sheets are aligned with said common edge of said wall corner that said first and second decorative patterns are harmonized to create a three dimensional decorative effect for said wall corner.

2. The decorative article, as recited in claim 1, wherein said first and second decorative sheets are integrally extended along a folding line such that said first and second decorative sheets are folded in an overlapped manner at said folding line and are unfolded for attaching to said first and second wall surfaces respectively to align said folding line with said common edge.

3. The decorative article, as recited in claim 1, further comprising a third decorative sheet having a third attaching side adapted for detachably attaching on a third wall surface that one of said first, second, and third wall surfaces is a ceiling wall surface, and a third decorative side containing a third decorative pattern thereon to harmonize with said first and second decorative patterns so as to create a three dimensional decorative effect for said wall corner.

4. The decorative article, as recited in claim 2, further comprising a third decorative sheet having a third attaching side adapted for detachably attaching on a third wall surface that one of said first, second, and third wall surfaces is a ceiling wall surface, and a third decorative side containing a third decorative pattern thereon to harmonize with said first and second decorative patterns so as to create a three dimensional decorative effect for said wall corner.

5. The decorative article, as recited in claim 1, wherein said first and second attaching sides are two laminating sides adapted for reusably attaching to said first and second wall surfaces respectively and for being removably peeled off from said first and second wall surfaces respectively.

6. The decorative article, as recited in claim 4, wherein said first, second, and third attaching sides are three laminating sides adapted for reusably attaching to said first, second, and third wall surfaces respectively and for being removably peeled off from said first, second, and third wall surfaces respectively.

7. The decorative article, as recited in claim 1, further comprising a decorative accessory kit provided at said first and second decorative sheets for outwardly protruding from said first and second wall surfaces to enhance said three dimensional decorative effect at said wall corner.

8. The decorative article, as recited in claim 6, further comprising a decorative accessory kit provided at said first and second decorative sheets for outwardly protruding from said first and second wall surfaces to enhance said three dimensional decorative effect at said wall corner.

9. The decorative article, as recited in claim 7, wherein said decorative accessory kit comprises an ornamental element extended between said first and second decorative sheets such that when said first and second decorative sheets are attached to said first and second wall surfaces respectively, said ornamental element is popped up from said wall corner to create a pop-up three dimensional decorative effect at said wall corner.

10. The decorative article, as recited in claim 8, wherein said decorative accessory kit comprises an ornamental element extended between said first and second decorative sheets such that when said first and second decorative sheets are attached to said first and second wall surfaces respectively, said ornamental element is popped up from said wall corner to create a pop-up three dimensional decorative effect at said wall corner.

11. The decorative article, as recited in claim 10, wherein said ornamental element has two peripheral sides integrally extended from said first and second decorative sheets respectively, such that when said first and second decorative sheets are unfolded for attaching on said first and second wall surfaces respectively, said ornamental element is outwardly popped between said first and second decorative sheets.

12. The decorative article, as recited in claim 10, wherein said ornamental element has two peripheral sides detachably laminating on said first and second decorative sheets respectively, such that when said first and second decorative sheets are attached on said first and second wall surfaces respectively, said ornamental element is outwardly popped between said first and second decorative sheets.

13. The decorative article, as recited in claim 7, wherein said decorative accessory kit comprises a texture element selectively attached to at least one of said first and second decorative sheets at said first and second decorative sides thereof to create a three dimensional decorative effect with real texture enhancement.

14. The decorative article, as recited in claim 8, wherein said decorative accessory kit comprises a texture element selectively attached to at least one of said first and second decorative sheets at said first and second decorative sides thereof to create a three dimensional decorative effect with real texture enhancement.

15. The decorative article, as recited in claim 10, wherein said decorative accessory kit further comprises a texture element selectively attached to at least one of said first and second decorative sheets at said first and second decorative sides thereof to create a three dimensional decorative effect with real texture enhancement.

16. The decorative article, as recited in claim 7, wherein said decorative accessory kit comprises an illumination element selectively attached to at least one of said first and second decorative sheets at said first and second decorative sides thereof to create a three dimensional decorative effect with light enhancement.

17. The decorative article, as recited in claim 8, wherein said decorative accessory kit comprises an illumination element selectively attached to at least one of said first and second decorative sheets at said first and second decorative sides thereof to create a three dimensional decorative effect with light enhancement.

18. The decorative article, as recited in claim 15, wherein said decorative accessory kit further comprises an illumination element selectively attached to at least one of said first and second decorative sheets at said first and second decorative sides thereof to create a three dimensional decorative effect with light enhancement.

19. The decorative article, as recited in claim 8, wherein said decorative accessory kit comprises a hanging element detachably mounted on one of said first, second, and third decorative sheets for suspendedly hanging at said ceiling wall surface to further enhance an aesthetic and decorative configuration of the three dimensional decorative effect.

20. The decorative article, as recited in claim 18, wherein said decorative accessory kit comprises a hanging element detachably mounted on one of said first, second, and third decorative sheets for suspendedly hanging at said ceiling wall surface to further enhance an aesthetic and decorative configuration of the three dimensional decorative effect.
